(19) United States
(12) Patent Application Publication
(10) Pub. No.: US 2026/0005236 A1
(43) Pub. Date: Jan. 1, 2026

(54) LITHIUM SECONDARY BATTERY ANODE COMPRISING PATTERN, AND LITHIUM SECONDARY BATTERY COMPRISING ANODE

(71) Applicant: LG ENERGY SOLUTION LTD., Seoul (KR)

(72) Inventors: Su Jin PARK, Daejeon (KR); Yohan KWON, Daejeon (KR); Sangmin LEE, Daejeon (KR); Jaewook LEE, Daejeon (KR)

(21) Appl. No.: 18/992,958

(22) PCT Filed: Dec. 14, 2023
(86) PCT No.: PCT/KR2023/020620

§ 371 Date: Jan. 9, 2025

(30) Foreign Application Priority Data
Dec. 15, 2022 (KR) 10-2022--01755723

(51) Int. Cl. H01M 4/48; H01M 4/02; H01M 4/131; H01M 10/052

(52) U.S. Cl. CPC H01M 4/48; H01M 4/131; H01M 10/052; H01M 2004/027

(57) ABSTRACT

The present disclosure relates to a negative electrode for a lithium secondary battery including a pattern, and a lithium secondary battery including a negative electrode.

### CROSS-REFERENCE TO RELATED APPLICATIONS

This application is a National Phase entry pursuant to 35 U.S.C. $371 of International Application No. PCT/KR2023/020620, filed on Dec. 14, 2023, and claims priority to and the benefit of Korean Patent Application No. 10-2022-0175723 filed in the Korean Intellectual Property Office on Dec. 15, 2022, the entire contents of each of which are incorporated herein by reference in their entirety for all purposes as if fully set forth herein.

### TECHNICAL FIELD

The present disclosure relates to a negative electrode for a lithium secondary battery including a pattern, and a lithium secondary battery including a negative electrode.

### BACKGROUND

Due to the rapid increase in the use of fossil fuels, the demand for the use of alternative energy or clean energy is increasing, and as part thereof, the fields that are being studied most actively are the fields of power generation and power storage using an electrochemical reaction.

At present, a secondary battery is a representative example of an electrochemical device that utilizes such electrochemical energy, and the range of use thereof is gradually expanding.

Along with the technological development and the increase in demand for mobile devices, the demand for secondary batteries as an energy source is sharply increasing. Among such secondary batteries, lithium secondary batteries having high energy density and voltage, long cycle life, and low self-discharging rate have been commercialized and widely used. In addition, research is being actively conducted on methods for manufacturing a high-density electrode having a higher energy density per unit volume as an electrode for such a high-capacity lithium secondary battery.

In general, a secondary battery includes a positive electrode, a negative electrode, an electrolyte, and a separator. The negative electrode includes a negative electrode active material for intercalating and deintercalating lithium ions coming out from the positive electrode, and silicon-based particles having a high discharge capacity may be used as the negative electrode active material.

In particular, according to the demand for high density energy batteries in recent years, research is being actively conducted into methods for increasing capacity by using a silicon-based compound such as Si/C and SiOx having a capacity 10 times or higher than that of a graphite-based material, as a negative electrode active material. However, as compared with graphite-based materials that are typically used, the silicon-based compound that is a high-capacity material has a large capacity but may undergo rapid volume expansion during charging, thereby disconnecting a conductive path to degrade battery characteristics.

Accordingly, in order to address problems that may arise when the silicon-based compound is used as the negative electrode active material, methods of suppressing the volume expansion itself such as a method of controlling a driving potential, a method involving additionally further coating a thin film on an active material layer and a method of controlling a particle diameter of a silicon-based compound, or various measures for preventing a conductive path from being disconnected have been discussed. However, the above methods may somewhat deteriorate the performance of a battery, and thus, the application thereof is limited, so that there is still a limitation in commercializing the manufacture of a battery including a negative electrode having a high content of a silicon-based compound.

In other words, while a negative electrode using a silicon-based active material can maximize capacity characteristics and satisfy rapid charging performance, no method has been found to solve the problem caused by the volume expansion of the silicon-based active material itself as described above. In particular, research is being conducted to control the volume expansion of the negative electrode, which includes a high content of silicon-based active material, by using a conductive material and a binder together. However, since the conductive material and the binder are included in small amounts compared to the active material, control of the contents thereof can be very limited. That is, there are many limitations in changing the composition and content.

Therefore, there is a need for research capable of suppressing the volume expansion of the silicon-based active material due to intercalation and deintercalation of lithium during charging and discharging even when the silicon-based active material is used as a negative electrode active material in order to improve capacity performance.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Research is being conducted to control the volume expansion of the negative electrode, which must include a high content of silicon-based active material, by using a conductive material and a binder together. However, since the conductive material and the binder may beincluded in small amounts compared to the active material, control of the contents thereof is very limited. That is, there are many limitations in changing the composition and content.

In regard to this, according to certain aspects, it has been found through research that the above-described problems can be at least partly addressed, and even solved, when a pattern is introduced into a negative electrode active material layer of a negative electrode including a silicon-based active material and the pattern satisfies a certain volume.

Accordingly, aspects of the present disclosure relate to a negative electrode for a lithium secondary battery including a pattern capable of at least partly addressing, and even solving, the problems described above, and a lithium secondary battery including the negative electrode.

An exemplary embodiment of the present disclosure provides a negative electrode for a lithium secondary battery including: a negative electrode current collector layer; and a negative electrode active material layer formed on at least one surface, or even both surfaces, of the negative electrode current collector layer, in which the negative electrode active material layer includes a pattern portion and satisfies Formula 1 below:

$$5 \leq [ B / ( A + B ) ] \times 100 ( \% ) \leq 30 \qquad Formula 1$$

in Formula 1 above,
A refers to a volume of the negative electrode active material layer excluding the pattern portion, and
B refers to a volume of the pattern portion of the negative electrode active material layer.

An exemplary embodiment of the present disclosure provides a lithium secondary battery including: a positive electrode; the negative electrode for a lithium secondary battery according to aspects of the present disclosure; a separator provided between the positive electrode and the negative electrode; and an electrolyte.

The negative electrode for a lithium secondary battery according to aspects of the present disclosure includes a silicon-based active material and targets high capacity and high energy density. In this case, according to certain aspects, the silicon-based active material is included in a high content in the negative electrode active material layer, and accordingly, volume expansion during charging and discharging may be problematic. In the case of the negative electrode for a lithium secondary battery according to aspects of the present disclosure, the negative electrode active material layer includes a pattern portion, and in particular, the volumes of the pattern portion and the negative electrode active material layer may satisfy the relationship of Formula 1 above.

That is, according to certain aspects, the volume expansion can be solved by adjusting the physical volume relationship while maintaining the composition, rather than adjusting the composition of the negative electrode active material layer. According to certain embodiments, when using a silicon-based negative electrode in the end, in order to satisfy a range (less than 5 to 10%) within which the volume expansion rate of the negative electrode active material layer does not pose a problem for use, the volume of the pattern portion can be set as much as that, and the ratio of the volumes can be adjusted to the range of Formula 1 above.

Accordingly, in certain embodiments, the negative electrode including a negative electrode active material layer that satisfies Formula 1 above can maximize the life characteristics of a lithium secondary battery by reducing the volume expansion during charging and discharging, and can provide a lithium secondary battery with excellent rapid charging performance while having the characteristics of high density and high capacity, which are the advantages of a silicon-based negative electrode.

The above-described configuration can have an advantageous effect not only for stack-type pouch batteries, but also for cylindrical and prismatic batteries wound into a roll shape, and in the above configuration, according to certain embodiments, there is no difference in volume expansion even when the formation charging speed is increased compared to the existing condition. In addition, according to certain aspects, features of reducing not only expansions in the x and y directions but also thickness change in the z direction.

### BRIEF DESCRIPTION OF DRAWINGS

FIG. 1 is a view showing a stack structure of a negative electrode for a lithium secondary battery according to an exemplary embodiment of the present disclosure.

FIG. 2 is a view showing a stack structure of a lithium secondary battery according to an exemplary embodiment of the present disclosure.

FIG. 3 is a view showing a structure in which an active material layer of a negative electrode for a lithium secondary battery according to an exemplary embodiment of the present disclosure is patterned.

### EXPLANATION OF REFERENCE NUMERALS AND SYMBOLS

10: negative electrode current collector layer
20: negative electrode active material layer
30: separator
40: positive electrode active material layer
50: positive electrode current collector layer
60: pattern portion
100: negative electrode for lithium secondary battery
200: positive electrode for lithium secondary battery

### DETAILED DESCRIPTION

Before describing the present invention, some terms are first defined.

When one part “includes”, “comprises” or “has” one constituent element in the present disclosure, unless otherwise specifically described, this does not mean that another constituent element is excluded, but means that another constituent element may be further included.

In the present disclosure, ‘p to q’ means a range of ‘p or more and q or less’.

In this disclosure, the “specific surface area” is measured by the BET method, and specifically, is calculated from a nitrogen gas adsorption amount at a liquid nitrogen temperature (77K) by using BELSORP-mino II available from BEL Japan, Inc. That is, in the present disclosure, the BET specific surface area may refer to the specific surface area measured by the above measurement method.

In the present disclosure, “Dn” refers to a particle size distribution, and refers to a particle diameter at the n % point in the cumulative distribution of the number of particles according to the particle diameter. That is, D50 is a particle diameter (average particle diameter) at the 50% point in the cumulative distribution of the number of particles according to the particle diameter, D90 is a particle diameter at the 90% point in the cumulative distribution of the number of particles according to the particle diameter, and D10 is a particle diameter at the 10% point in the cumulative distribution of the number of particles according to the particle diameter. Meanwhile, the average particle diameter may be measured using a laser diffraction method. Specifically, after powder to be measured is dispersed in a dispersion medium, the resultant dispersion is introduced into a commercially available laser diffraction particle size measurement apparatus (for example, Microtrac S3500) in which a difference in a diffraction pattern according to the particle size is measured, when a laser beam passes through particles, and then a particle size distribution is calculated.

In an exemplary embodiment of the present disclosure, the particle size or particle diameter may mean an average diameter or representative diameter of each crystal grain constituting the powder.

In the present disclosure, the description “a polymer includes a certain monomer as a monomer unit” means that the monomer participates in a polymerization reaction and is included as a repeating unit in the polymer. In the present disclosure, when a polymer includes a monomer, this is interpreted as the same as that the polymer includes a monomer as a monomer unit.

In the present disclosure, it is understood that the term ‘polymer’ is used in a broad sense including a copolymer unless otherwise specified as ‘a homopolymer’.

In the present disclosure, a weight-average molecular weight (Mw) and a number-average molecular weight (Mn) are polystyrene converted molecular weights measured by gel permeation chromatography (GPC) while employing, as a standard material, a monodispersed polystyrene polymer (standard sample) having various degrees of polymerization commercially available for measuring a molecular weight. In the present disclosure, a molecular weight refers to a weight-average molecular weight unless particularly described otherwise.

Hereinafter, embodiments of the present disclosure will be described in detail with reference to the drawings so that one skilled in the art can readily implement aspects of the present invention. However, the present invention may be embodied in various different forms, and is not limited to the following descriptions.

An exemplary embodiment of the present disclosure provides a negative electrode for a lithium secondary battery including: a negative electrode current collector layer; and a negative electrode active material layer formed on at least one surface, or even both surfaces, of the negative electrode current collector layer, in which the negative electrode active material layer includes a pattern portion and satisfies Formula 1 below:

$$5 \leq [ B / ( A + B ) ] \times 100 ( \% ) \leq 30 \qquad Formula 1$$

in Formula 1 above,
A refers to a volume of the negative electrode active material layer excluding the pattern portion, and
B refers to a volume of the pattern portion of the negative electrode active material layer.

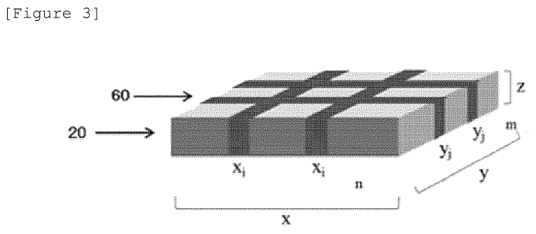

FIG. 3 is a view showing a structure in which an active material of a negative electrode for a lithium secondary battery according to an exemplary embodiment of the present disclosure is patterned. Specifically, A refers to a volume of the negative electrode active material layer excluding the pattern portion, and B refers to a volume of the pattern portion in the negative electrode active material layer.

In the present disclosure, the pattern portion may be defined as an uncoated portion region of the negative electrode active material layer, in which a negative electrode active material layer is not provided. That is, the pattern portion is a portion on top of the negative electrode current collector layer, in which a negative electrode active material layer is not provided, and is different from a structure in which the negative electrode active material layer has a pattern shape by being separated by a partition wall or other materials.

According to aspects of the present disclosure, the negative electrode including a negative electrode active material layer that satisfies Formula 1 above can maximize the life characteristics of a lithium secondary battery by reducing the volume expansion during charging and discharging, and can provide a lithium secondary battery with excellent rapid charging performance while having the characteristics of high density and high capacity, which are the advantages of a silicon-based negative electrode. The pattern portion according to aspects of the present disclosure can play the above role only when the negative electrode active material layer is not formed. If a partition wall is formed for demarcation, a portion blocked by the partition wall cannot accommodate the volume expansion, unlike the pattern portion according to aspects of the present disclosure, so the effect of reducing the volume expansion is not obtained.

In an exemplary embodiment of the present disclosure, Formula 1 above may satisfy a range of 5≤[B/(A+B)]×100(%)≤30, specifically 6≤[B/(A+B)]×100(%)≤25, and more specifically 10≤[B/(A+B)]×100(%)≤25.

Embodiments of the present disclosure may solve the problem of the volume expansion by adjusting the physical volume relationship while maintaining the composition, rather than adjusting the composition of the negative electrode active material layer. According to certain aspects, when using a silicon-based negative electrode in the end, in order to satisfy a range (less than 5 to 10%) within which the volume expansion rate of the negative electrode active material layer does not pose a problem for use, the volume of the pattern portion can be set as much as that, and the ratio of the volumes canbe adjusted to the range of Formula 1 above.

According to certain aspects, when the range of Formula 1 above is satisfied, the volume expansion can be controlled not only in stack-type pouch batteries but also in cylindrical and prismatic batteries wound into a roll shape, resulting in an advantageous effect. In addition, according to certain aspects, there is no difference in volume expansion even when the formation charging speed is increased compared to the existing condition, and not only expansions in the x and y directions but also thickness change in the z direction can be reduced.

In an exemplary embodiment of the present disclosure, Formula 1 above means a ratio of a volume of the pattern portion to a total volume of the negative electrode active material layer, and the units of Formula 1 may be expressed as %.

In an exemplary embodiment of the present disclosure, there is provided the negative electrode for the lithium secondary battery in which the negative electrode active material layer satisfies Formula 2 below:

$$[ \{ ( x + x 1 ) ( y + y 1 ) ( z + z 1 ) - x yz \} / xyz ] \times 100 ( \% ) < 50 \% \qquad Formula 2$$

in Formula 2 above,
x, y, and z are a total width, a total length, and a total thickness of the negative electrode active material layer including the pattern, respectively, after
manufacturing the negative electrode for a lithium secondary battery, and
   x1, y1, and z1 are changes in length in the x, y, and z directions, respectively, after manufacturing the negative electrode for a lithium secondary battery, and immediately after ⅓C CC-CV charge to 4.2V (0.05 C cut-off) followed by ⅓C CC discharge to 2.5V.

Formula 2 above may satisfy Formula 2<50%, and specifically Formula 2<48%, or Formula 2<45%, and 5%<Formula 2, 10%<Formula 2, 15%<Formula 2, 20%<Formula 2, or 25%<Formula 2.

That is, according to certain aspects, Formula 2 above may mean a volume expansion rate of an entire volume of the negative electrode active material layer for the lithium secondary battery in a fresh state after undergoing an activation process (i.e., ⅓C CC-CV single charge to 4.2V (0.05 C cut-off) followed by ⅓C CC discharge to 2.5V). According to certain aspects, when the negative electrode active material layer includes a pattern portion that satisfies the range of Formula 1 above, the range of Formula 2 above can be satisfied.

Specifically, Formula 2 above can be confirmed in FIG. 3. x is a length in a transverse direction (TD), meaning a total width of the negative electrode active material layer, y is a length in a machine direction (MD, meaning a total length of the negative electrode active material layer, and z refers to a thickness of the negative electrode active material layer. In this case, x1, y1, and z1 refer to changes in length in the x, y, and z directions, respectively, after manufacturing the negative electrode for the lithium secondary battery followed by the activation process described above.

In an exemplary embodiment of the present disclosure, there is provided the negative electrode for the lithium secondary battery in which the negative electrode active material layer satisfies Formula 3 below:

$$[ \{ ( x + x 2 ) ( y + y 2 ) ( z + z 2 ) - x yz \} / xyz ] \times 100 ( \% ) < 100 \% \qquad Formula 3$$

in Formula 3 above,
x, y, and z are the total width, the total length, and the total thickness of the negative electrode active material layer including the pattern portion, respectively, after manufacturing the negative electrode for the lithium secondary battery, and
x2, y2, and z2 refer to changes in length in the x, y, and z directions, respectively, after manufacturing the negative electrode for the lithium secondary battery followed by 300 cycles of 1 C CC-CV charge to 4.2V (0.05 C cut-off) and 0.50 CC discharge to 3.0V.

Formula 3 above may satisfy Formula 3<100%, and specifically Formula 3<97%, or Formula 3<95%, and 50%<Formula 3, 55%<Formula 3, or 60% Formula 3.

That is, according to certain aspects, Formula 3 above may mean a volume expansion rate of an entire volume of the negative electrode active material layer for the lithium secondary battery in a fresh state after undergoing 300 cycles (i.e., 300 cycles of 1 C CC-CV charge to 4.2V (0.05 C cut-off) followed by 0.5 C CC discharge to 3.0V). According to certain aspects, when the negative electrode active material layer includes a pattern portion that satisfies the range of Formula 1 above, the range of Formula 3 above can be satisfied.

Specifically, according to certain aspects, Formula 3 above can be confirmed in FIG. 3. x is a length in a TD direction, meaning a total width of the negative electrode active material layer, y is a length in an MD direction, meaning a total length of the negative electrode active material layer, and z refers to a thickness of the negative electrode active material layer. In this case, x2, y2, and z2 refer to changes in length in the x, y, and z directions, respectively, after manufacturing the negative electrode for a lithium secondary battery followed by the 300 cycles described above.

In an exemplary embodiment of the present disclosure, there is provided the negative electrode for the lithium secondary battery in which the negative electrode active material layer satisfies Formula 4 below:

$$5 \leq xyz - \{ ( xi \times n ) yz + x ( yj \times m ) z - nmxiyj \} \leq 30 \qquad Formula 4$$

in Formula 4 above,
x, y, and z are the total width, the total length, and the total thickness of the negative electrode active material layer including the pattern portion, respectively, after manufacturing the negative electrode for a lithium secondary battery, and
n is a number of patterns in the x direction,
m is a number of patterns in the y direction,
xi refers to a width of each pattern in the x direction,
yj refers to a length of each pattern in the y direction,
i is an integer ranging from 1 to n, and
j is an integer ranging from 1 to m.

The embodiments as shown in FIG. 3 corresponds to a case where the pattern portion is formed as a 2D pattern. In this case, n is the number of patterns in the x-direction. When n is 3, i can be expressed as an integer ranging from 1 to 3, and x1, x2, and x3 may refer to a width of each pattern. Similarly, m is the number of patterns in the y direction. When m is 3, j is an integer ranging from 1 to 3, and y1, y2, and y3 may refer to a length of each pattern.

According to certain aspects, Formula 4 above may mean a volume excluding a volume of the pattern portion included in the negative electrode active material layer based on the total volume of the negative electrode active material layer, and may mean an actual volume included by the negative electrode active material layer. That is, according to certain aspects, if Formula 4 above is less than the above-described range, the capacity characteristics may not be ensured, and if Formula 4 exceeds the above-described range, the volume expansion may not be controlled, and the life characteristics may be somewhat lowered.

In an exemplary embodiment of the present disclosure, there is provided the negative electrode for the lithium secondary battery in which the pattern portion includes one or more selected from the group consisting of a 1D pattern, a 2D pattern, a V pattern, and a U pattern.

In this case, the 1D pattern may mean a pattern that is formed only in the length direction or the width direction in the negative electrode active material layer, and the 2D pattern may mean a pattern that is formed in both the length direction and the width direction in the negative electrode active material layer. In addition, the V or U pattern may mean that a shape of a formed pattern is a V shape or a U shape.

According to embodiments of the present disclosure, there is provided the negative electrode for the lithium secondary battery in which the negative electrode active material layer includes a negative electrode active material layer composition, and the negative electrode active material layer composition includes a silicon-based active material, a negative electrode conductive material, and a negative electrode binder.

In this case, the silicon-based active material can be used as a negative electrode active material.

The negative electrode active material layer composition according to an exemplary embodiment of the present disclosure may at least partly address, and even solve, the problems in the related art by using the negative electrode active material layer having the above-described pattern portion even when a silicon-based active material is used.

In an exemplary embodiment of the present disclosure, the silicon-based active material may include one or more selected from the group consisting of SiOx (x=0), SiOx (0<x<2), SiC, and a Si alloy.

The active material according to aspects of the present disclosure includes a silicon-based active material. The silicon-based active material may be SiOx, Si/C, or Si. SiOx may include a compound represented by SiOx (0≤x<2). According to certain aspects, since SiO₂ does not react with lithium ions and cannot store lithium, x is preferably within the above range. The silicon-based active material may be Si/C composed of a composite of Si and C, or Si. In addition, two or more of the above silicon-based active materials may be mixed and used. The negative electrode active material may further include a carbon-based active material together with the silicon-based active material described above. The carbon-based active material can contribute to improving cycle characteristics or battery lifespan performance of the negative electrode or secondary battery according to aspects of the present disclosure.

In general, a silicon-based active material is known to have a capacity that is 10 times higher than that of a carbon-based active material, and accordingly, when the silicon-based active material is applied to a negative electrode, it is expected that an electrode having a high level of energy density can be implemented even with a thin thickness.

In an exemplary embodiment of the present disclosure, the silicon-based active material may include one or more selected from the group consisting of SiOx (x=0) and SiOx (0<x<2), and may include the SiOx (x=0) in an amount of 70 parts by weight or more based on 100 parts by weight of the silicon-based active material.

In another exemplary embodiment, the silicon-based active material may include SiOx (x=0) in an amount of 70 parts by weight or more, preferably 80 parts by weight or more, and more preferably 90 parts by weight or more, and 100 parts by weight or less, preferably 99 parts by weight or less, and more preferably 95 parts by weight or less based on 100 parts by weight of the silicon-based active material.

The silicon-based active material according to the present disclosure includes 70 parts by weight or more of SiOx (x=0) based on 100 parts by weight of the silicon-based active material. When compared with a silicon-based active material in which a SiOx (0<x<2)-based active material is used as a main material, the theoretical capacity thereof is much lower than that of the silicon-based active material of the present disclosure. That is, if a SiOx (0<x<2)-based active material is used, even when the active material itself is treated in any way, it may not be possible to implement conditions equivalent to the charging and discharging capacities of the silicon-based active material according to aspects of the present disclosure.

In an exemplary embodiment of the present disclosure, pure silicon (Si) may be used as the silicon-based active material. The use of pure silicon (Si) as the silicon-based active material may mean that, based on 100 parts by weight of the total silicon-based active material as described above, pure Si particles (SiOx (x=0)) not bonded to other particles or elements are included within the above range.

According to certain aspects, the capacity of the silicon-based active material is significantly higher than that of a graphite-based active material that is typically used, so that there have been more attempts to apply the same. However, the volume expansion rate of the silicon-based active material during charging/discharging can be high, so that typically only a small amount thereof is mixed and used with a graphite-based active material.

Therefore, according to aspects of the present disclosure, a negative electrode including a pattern portion satisfying Formula 1 above can be manufactured in order to at least partly address, and even solve, the problems of maintaining the conductive path and the combination of the conductive material, the binder, and the active material with respect to the volume expansion described above while using the silicon-based active material as the negative electrode active material for improving the capacity performance.

Note that an average particle diameter (D50) of the silicon-based active material according to aspects of the present disclosure may be 5 μm to 10 μm, specifically 5.5 μm to 8 μm, and more specifically 6 μm to 7 μm. According to certain aspects, when the average particle diameter is within the above range, a specific surface area of the particles may be within a suitable range, so that a viscosity of a negative electrode slurry can be formed within an appropriate range. Accordingly, the particles constituting the negative electrode slurry may be smoothly dispersed. In addition, according to certain aspects, when the size of the silicon-based active material has a value equal to or greater than the lower limit value of the range, a contact area between the silicon particles and the conductive material may be excellent due to the composite made of the conductive material and the binder in the negative electrode slurry, so that a sustaining possibility of the conductive network may increase, resulting in an increase in the capacity retention rate. Note that, according to certain aspects, when the average particle diameter satisfies the above range, excessively large silicon particles can be excluded, so that a smooth surface of the negative electrode can be formed. Accordingly, in certain aspects, a current density non-uniformity phenomenon during charging and discharging can be prevented.

In an exemplary embodiment of the present disclosure, the silicon-based active material generally has a characteristic BET specific surface area. The BET specific surface area of the silicon-based active material is preferably 0.1 m²/g to 150.0 m²/g, more preferably 0.1 m²/g to 100.0 m²/g, particularly preferably 0.2 m²/g to 80.0 m²/g, and most preferably 0.2 m²/g to 18.0 m²/g. The BET specific surface area is measured in accordance with DIN 66131 (using nitrogen).

In an exemplary embodiment of the present disclosure, the silicon-based active material may be present, for example, in a crystalline or amorphous form, and is preferably not porous. The silicon particles are preferably spherical or fragment-shaped particles. Alternatively, but less preferably, the silicon particles may also have a fiber structure or be present in the form of a silicon-containing film or coating.

In an exemplary embodiment of the present disclosure, the silicon-based active material may be included in an amount of 60 parts by weight or more based on 100 parts by weight of the negative electrode active material layer composition.

In another exemplary embodiment, based on 100 parts by weight of the negative electrode active material layer composition, 60 parts by weight or more, preferably 65 parts by weight or more, and more preferably 70 parts by weight or more, and 95 parts by weight or less, preferably 90 parts by weight or less, and more preferably 85 parts by weight or less of the silicon-based active material may be included.

The negative electrode active material layer composition according to aspects of the present disclosure uses the specific conductive material and binder capable of controlling the volume expansion rate during charging and discharging even when the silicon-based active material having a significantly high capacity is used within the above range, and the pattern portion satisfying the range of Formula 1 above is provided, so that output characteristics in charging and discharging are excellent while the performance of the negative electrode is not degraded.

In an exemplary embodiment of the present disclosure, the silicon-based active material may have a non-spherical shape and its sphericity (circularity) is, for example, 0.9 or less, for example, 0.7 to 0.9, for example 0.8 to 0.9, and for example 0.85 to 0.9.

In the present disclosure, the circularity is determined by Formula 1-1 below, in which A is an area and P is a boundary line.

$$4 π A / {P}^{2} \qquad Formula 1 - 1$$

In the related art, it is typical to use only graphite-based compounds as the negative electrode active material. However, in recent years, as the demand for high-capacity batteries is increasing, attempts to mix and use silicon-based compounds have been increasing in order to increase capacity. However, in the case of a silicon-based compound, even when the characteristics of the silicon-based active material itself are adjusted as described above according to aspects of the present disclosure, the volume may rapidly expand during the charging/discharging, thereby causing some problems of damaging the conductive path formed in the negative electrode active material layer.

Therefore, in an exemplary embodiment of the present disclosure, the negative electrode conductive material may include one or more selected from the group consisting of a point-like conductive material, a planar conductive material and a linear conductive material.

In an exemplary embodiment of the present disclosure, the point-like conductive material refers to a point-like or spherical conductive material that may be used for improving conductivity of the negative electrode, and has conductivity without causing a chemical change. Specifically, the point-like conductive material may be one or more species selected from the group consisting of natural graphite, artificial graphite, carbon black, acetylene black, Ketjen black, channel black, furnace black, lamp black, thermal black, conductive fiber, fluorocarbon, aluminum powder, nickel powder, zinc oxide, potassium titanate, titanium oxide, and a polyphenylene derivative, and preferably may include carbon black in terms of high conductivity and excellent dispersibility.

In an exemplary embodiment of the present disclosure, the point-like conductive material may have a BET specific surface area of 40 m²/g or greater and 70 m²/g or less, preferably 45 m²/g or greater and 65 m²/g or less, and more preferably 50 m²/g or greater and 60 m²/g or less.

In an exemplary embodiment of the present disclosure, a content of the functional group (volatile matter) of the point-like conductive material may satisfy a range of 0.01% or more and 1% or less, preferably 0.01% or more and 0.3% or less, and more preferably 0.01% or more and 0.1% or less.

In particular, when the content of the functional group of the point-like conductive material satisfies the above range, a functional group is present on a surface of the point-like conductive material, so that the point-like conductive material can be smoothly dispersed in a solvent when water is used as the solvent. In particular, according to aspects of the present disclosure, when the silicon particle and the specific binder are used, the content of the functional group of the point-like conductive material can be lowered, which can exhibit an excellent effect on improving dispersibility.

In an exemplary embodiment of the present disclosure, the point-like conductive material having the content of the functional group within the range described above is included together with the silicon-based active material, and the content of the functional group can be adjusted according to a degree of heat treatment of the point-like conductive material.

In an exemplary embodiment of the present disclosure, the particle diameter of the point-like conductive material may be 10 nm to 100 nm, preferably 20 nm to 90 nm, and more preferably 20 nm to 60 nm.

In an exemplary embodiment of the present disclosure, the negative electrode conductive material may include a planar conductive material.

According to certain aspects, the planar conductive material improves conductivity by increasing surface contact between silicon particles in the negative electrode, and at the same time, can serve to suppress disconnection of the conductive path due to the volume expansion. The planar conductive material may be expressed as a plate-like conductive material or a bulk-type conductive material.

In an exemplary embodiment of the present disclosure, the planar conductive material may be provided in the form of binding to the surfaces of the silicon-based particles. Specifically, the planar conductive material may be provided in such a form that an —OH group or —O on the surface of the silicon-based particle binds to a hydrophilic group of the planar conductive material.

In an exemplary embodiment of the present disclosure, the planar conductive material may include one or more selected from the group consisting of plate-like graphite, graphene, graphene oxide, and graphite flake, and preferably may be plate-like graphite.

In an exemplary embodiment of the present disclosure, an average particle diameter (D50) of the planar conductive material may be 2 μm to 7 μm, specifically 3 μm to 6 μm, and more specifically 3.5 μm to 5 μm. According to certain aspects, when the above range is satisfied, the sufficient particle size can result in easy dispersion without causing an excessive increase in viscosity of the negative electrode slurry. Therefore, the dispersion effect can be excellent when dispersing using the same equipment and time.

In an exemplary embodiment of the present disclosure, the planar conductive material may have D10 of 0.5 μm or greater and 2.0 μm or less, D50 of 2.5 μm or greater and 3.5 μm or less, and D90 of 6.5 μm or greater and 15.0 μm or less.

In an exemplary embodiment of the present disclosure, for the planar conductive material, a planar conductive material with a high specific surface area having a high BET specific surface area or a planar conductive material with a low specific surface area may be used.

In an exemplary embodiment of the present disclosure, for the planar conductive material, a planar conductive material with a high specific surface area or a planar conductive material with a low specific surface area may be used without limitation. However, in particular, the planar conductive material according to aspects of the present disclosure can be affected to some extent in the electrode performance by the dispersion effect, so that a planar conductive material with a low specific surface area that does not cause a problem in dispersion is used particularly preferably.

In an exemplary embodiment of the present disclosure, the planar conductive material may have a BET specific surface area of 1 m²/g or greater.

In another exemplary embodiment, the planar conductive material may have a BET specific surface area of 1 m²/g or greater and 500 m²/g or less, preferably 5 m²/g or greater and 300 m²/g or less, and more preferably 5 m²/g or greater and 250 m²/g or less.

For the planar conductive material according to aspects of the present disclosure, a planar conductive material with a high specific surface area or a planar conductive material with a low specific surface area may be used.

In another exemplary embodiment, the planar conductive material is a planar conductive material with a high specific surface area, and the BET specific surface area may satisfy a range of 50 m²/g or greater and 500 m²/g or less, preferably 80 m²/g or greater and 300 m²/g or less, and more preferably 100 m²/g or greater and 300 m²/g or less.

In another exemplary embodiment, the planar conductive material is a planar conductive material with a low specific surface area, and the BET specific surface area may satisfy a range of 1 m²/g or greater and 40 m²/g or less, preferably 5 m²/g or greater and 30 m²/g or less, and more preferably 5 m²/g or greater and 25 m²/g or less.

Other conductive materials may include linear conductive materials such as carbon nanotubes. The carbon nanotubes may be bundle-type carbon nanotubes. The bundle-type carbon nanotubes may include a plurality of carbon nanotube units. Specifically, the term ‘bundle type’ herein refers to, unless otherwise specified, a bundle or rope-shaped secondary shape in which a plurality of carbon nanotube units are aligned side by side in such an orientation that longitudinal axes of the carbon nanotube units are substantially the same, or are entangled. The carbon nanotube unit has a graphite sheet having a cylindrical shape with a nano-sized diameter, and has an sp2 bonding structure. In this case, the characteristics of a conductor or a semiconductor may be exhibited depending on the rolled angle and structure of the graphite sheet. As compared with entangled-type carbon nanotubes, the bundle-type carbon nanotubes can be more uniformly dispersed during the manufacture of the negative electrode, and can form more smoothly a conductive network in the negative electrode to improve the conductivity of the negative electrode.

Illustratively, the linear conductive material may be a single-walled carbon nanotube (SWCNT) with a large BET specific surface area, a linear form, a very small diameter, and a very long length. The linear conductive material such as SWCNT cannot be stretched through dispersion and has a strong ability to return to its original form when dried. As a result, the linear conductive material such as SWCNT has a strong ability to return to its original form when dried, so it generally is present in a form of wrapping or connecting a negative electrode active material or secondary agglomerate. The bonding method can be adsorption by van der Waals force.

In an exemplary embodiment of the present disclosure, the negative electrode conductive material may be included in an amount of 10 parts by weight or more and 40 parts by weight or less, based on 100 parts by weight of the negative electrode active material layer composition.

In another exemplary embodiment, the negative electrode conductive material may be included in an amount of 10 parts by weight or more and 40 parts by weight or less, preferably 10 parts by weight or more and 30 parts by weight or less, and more preferably 10 parts by weight or more and 25 parts by weight or less, based on 100 parts by weight of the negative electrode active material layer composition.

In an exemplary embodiment of the present disclosure, the negative electrode conductive material may include a planar conductive material and a linear conductive material.

In the exemplary embodiment of the present disclosure, the negative electrode conductive material may include 80 parts by weight or more and 99.9 parts by weight or less of the planar conductive material, and 0.1 part by weight or more and 20 parts by weight or less of the linear conductive material based on 100 parts by weight of the negative electrode conductive material.

In another exemplary embodiment, the negative electrode conductive material may include 80 parts by weight or more and 99.9 parts by weight or less, preferably 85 parts by weight or more and 99.9 parts by weight or less, and more preferably 95 parts by weight or more and 98 parts by weight or less of the planar conductive material based on 100 parts by weight of the negative electrode conductive material.

In another exemplary embodiment, the negative electrode conductive material may include 0.1 part by weight or more and 20 parts by weight or less, preferably 0.1 part by weight or more and 15 parts by weight or less, and more preferably 2 parts by weight or more and 5 parts by weight or less of the linear conductive material based on 100 parts by weight of the negative electrode conductive material.

In an exemplary embodiment of the present disclosure, the negative electrode conductive material includes the planar conductive material and the linear conductive material and satisfies the composition and ratio described above, respectively, so the life characteristics of an existing lithium secondary battery are not significantly affected, and particularly, the number of points where charging and discharging are possible can increase when the planar conductive material and the linear conductive material are included, so that output characteristics are excellent at a high C-rate and an amount of gas generation at high temperatures may be reduced.

The negative electrode conductive material according to aspects of the present disclosure has a completely different configuration from that of a positive electrode conductive material that is applied to the positive electrode. That is, the negative electrode conductive material according to aspects of the present disclosure serves to hold the contact between silicon-based active materials whose volume expansion of the electrode is very large due to charging and discharging, and the positive electrode conductive material serves to impart some conductivity while serving as a buffer when roll-pressed, and is completely different from the negative electrode conductive material according to aspects of the present disclosure in terms of configuration and role.

In addition, the negative electrode conductive material according to aspects of the present disclosure can be applied to a silicon-based active material, and has a completely different configuration from that of a conductive material that is applied to a graphite-based active material. That is, since a conductive material that is used for an electrode having a graphite-based active material simply has smaller particles than the active material, the conductive material has characteristics of improving output characteristics and imparting some conductivity, and is completely different from the negative electrode conductive material that is applied together with the silicon-based active material as in aspects of the present disclosure, in terms of configuration and role.

In an exemplary embodiment of the present disclosure, the planar conductive material that is used as the negative electrode conductive material described above has a different structure and role from those of the carbon-based active material that is generally used as the negative electrode active material. Specifically, the carbon-based active material that is used as the negative electrode active material may be artificial graphite or natural graphite, and refers to a material that is processed into a spherical or point-like shape and used so as to facilitate storage and release of lithium ions.

On the other hand, the planar conductive material that is used as the negative electrode conductive material is a material having a plane or plate-like shape, and may be expressed as plate-like graphite. That is, the planar conductive material may be a material that is included so as to maintain a conductive path in the negative electrode active material layer, and means a material for securing a conductive path in a plane shape inside the negative electrode active material layer, rather than playing a role in storing and releasing lithium.

That is, according to aspects of the present disclosure, the use of plate-like graphite as a conductive material can mean that graphite is processed into a planar or plate-like shape and used as a material for securing a conductive path rather than playing a role in storing or releasing lithium. In this case, the negative electrode active material included together has high-capacity characteristics with respect to storing and releasing lithium, and serves to store and release all lithium ions transferred from the positive electrode.

On the other hand, according to certain aspects of the present disclosure, the use of a carbon-based active material as an active material means that the carbon-based active material is processed into a point-like or spherical shape and used as a material for storing or releasing lithium.

In an exemplary embodiment of the present disclosure, the negative electrode binder may include at least one selected from the group consisting of polyvinylidenefluoride-hexafluoropropylene copolymer (PVDF-co-HFP), polyvinylidenefluoride, polyacrylonitrile, polymethylmethacrylate, polyvinyl alcohol, carboxymethylcellulose (CMC), starch, hydroxypropylcellulose, regenerated cellulose, polyvinylpyrrolidone, polytetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-described materials in which a hydrogen is substituted with Li, Na, Ca, etc., and may also include various copolymers thereof.

The negative electrode binder according to an exemplary embodiment of the present disclosure serves to hold the silicon-based active material and the negative electrode conductive material in order to prevent distortion and structural deformation of the negative electrode structure when the volume of the silicon-based active material expands and relaxes. When such roles are satisfied, all of the general negative electrode binders can be applied. Specifically, an aqueous binder may be used, and more specifically, a PAM-based binder may be used.

In an exemplary embodiment of the present disclosure, the negative electrode binder may be included in an amount of 30 parts by weight or less, preferably 25 parts by weight or less, more preferably 20 parts by weight or less, and 5 parts by weight or more, and 10 parts by weight or more, based on 100 parts by weight of the negative electrode active material layer composition.

Compared to existing carbon-based negative electrodes, according to certain aspects, when a Si-based negative electrode is used, an aqueous binder can be applied in parts by weight described above, which can allow the use of a point-like conductive material with a low functional group content. In addition, the above characteristics can allow the point-like conductive material to have hydrophobicity and the excellent bond strength between the conductive material/binder.

In an exemplary embodiment of the present disclosure, the negative electrode slurry including the negative electrode active material layer composition may be coated on one surface or both surfaces of the negative electrode current collector to form the negative electrode for the lithium secondary battery.

In an exemplary embodiment of the present disclosure, the negative electrode for the lithium secondary battery may be formed by applying and drying a negative electrode slurry including the negative electrode composition to one surface or both surfaces of the negative electrode current collector layer.

In an exemplary embodiment of the present disclosure, the negative electrode slurry may include a negative electrode active material layer composition and a slurry solvent.

In an exemplary embodiment of the present disclosure, a solid content of the negative electrode slurry may satisfy a range of 5% or more and 40% or less.

In another exemplary embodiment, the solid content of the negative electrode slurry may satisfy a range of 5% or more and 40% or less, preferably 7% or more and 35% or less, and more preferably 10% or more and 30% or less.

The solid content of the negative electrode slurry may mean a content of the negative electrode active material layer composition included in the negative electrode slurry, and may mean a content of the negative electrode active material layer composition based on 100 parts by weight of the negative electrode slurry.

According to certain aspects, when the solid content of the negative electrode slurry satisfies the above range, the viscosity is appropriate during formation of the negative electrode active material layer, so that particle agglomeration of the negative electrode composition can be minimized to efficiently form the negative electrode active material layer.

In an exemplary embodiment of the present disclosure, the slurry solvent may be used without limitation as long as it can disperse the negative electrode composition described above, and specifically, water or NMP may be used.

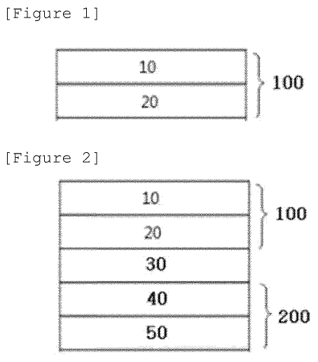

FIG. 1 is a view showing a stack structure of a negative electrode for a lithium secondary battery according to an exemplary embodiment of the present disclosure. Specifically, a negative electrode 100 for a lithium secondary battery can be seen which includes a negative electrode active material layer 20 on one surface of a negative electrode current collector layer 10. FIG. 1 shows that the negative electrode active material layer is formed on one surface of the negative electrode current collector layer, but the negative electrode active material layer may also be formed on both surfaces of the negative electrode current collector layer.

In an exemplary embodiment of the present disclosure, the negative electrode current collector layer generally has a thickness of 1 μm to 100 μm. Such a negative electrode current collector layer is not particularly limited as long as it has high conductivity without causing a chemical change in the battery. For example, copper, stainless steel, aluminum, nickel, titanium, fired carbon, copper or stainless steel each surface-treated with carbon, nickel, titanium, silver, or the like, an aluminum-cadmium alloy, or the like may be used. In addition, the negative electrode current collector layer may have microscopic irregularities formed on a surface to enhance a bonding force of the negative electrode active material, and may be used in various forms such as a film, a sheet, a foil, a net, a porous body, a foamed body, or a non-woven fabric body.

In an exemplary embodiment of the present disclosure, there is provided the negative electrode for the lithium secondary battery in which a thickness of the negative electrode current collector layer is 1 μm or greater and 100 μm or less and a thickness of the negative electrode active material layer is 20 μm or greater and 500 μm or less.

However, the thickness may be variously modified depending on a type and a use of negative electrode used, and is not limited thereto.

In an exemplary embodiment of the present disclosure, a porosity of the negative electrode active material layer may satisfy a range of 10% or greater and 60% or less.

In another exemplary embodiment, the porosity of the negative electrode active material layer may satisfy a range of 10% or greater and 60% or less, preferably 20% or greater and 50% or less, and more preferably 30% or greater and 45% or less.

The porosity varies depending on compositions and contents of the silicon-based active material, conductive material and binder included in the negative electrode active material layer, and in particular, may satisfy the range described above when the silicon-based active material according to aspects of the present disclosure and the conductive material are included in the specific compositions and contents, so that the electrode has electrical conductivity and resistance within appropriate ranges.

An exemplary embodiment of the present disclosure provides a lithium secondary battery including a positive electrode; the negative electrode for the lithium secondary battery according to aspects of the present disclosure; a separator provided between the positive electrode and the negative electrode; and an electrolyte.

FIG. 2 is a view showing a stack structure of a lithium secondary battery according to an exemplary embodiment of the present disclosure. Specifically, a negative electrode 100 for a lithium secondary battery including a negative electrode active material layer 20 on one surface of a negative electrode current collector layer 10 can be seen, a positive electrode 200 for a lithium secondary battery including a positive electrode active material layer 40 on one surface of a positive electrode current collector layer 50 can be seen, and the negative electrode 100 for a lithium secondary battery and the positive electrode 200 for a lithium secondary battery are formed in a stack structure with a separator 30 interposed therebetween.

The secondary battery according to an exemplary embodiment of the present disclosure may particularly include the negative electrode for the lithium secondary battery described above. Specifically, the secondary battery may include a negative electrode, a positive electrode, a separator interposed between the positive electrode and the negative electrode, and an electrolyte, and the negative electrode can be the same as the negative electrode described above. Since the negative electrode has been described above, a detailed description thereof is omitted.

The positive electrode may include a positive electrode current collector and a positive electrode active material layer formed on the positive electrode current collector and including the positive electrode active material.

In the positive electrode, the positive electrode current collector is not particularly limited as long as it has conductivity without causing a chemical change in the battery. For example, stainless steel, aluminum, nickel, titanium, fired carbon, aluminum or stainless steel each surface-treated with carbon, nickel, titanium, silver, or the like, or the like may be used. In addition, the positive electrode current collector may typically have a thickness of 3 to 500 μm, and a surface of the current collector may be formed with microscopic irregularities to enhance adhesive force of the positive electrode active material. For example, the positive electrode current collector may be used in various forms such as a film, a sheet, a foil, a net, a porous body, a foamed body, and a non-woven fabric body.

The positive electrode active material may be a positive electrode active material that is typically used. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide such as chemical formula Li_{1+c1}Mn_{2-c1}O₄ (0≤c1≤0.33), LiMnO₃, LiMn₂O₃ and LiMnO₂; a lithium copper oxide (Li₂CuO₂); a vanadium oxide such as LiV₃O₈, V₂O₅ and Cu₂V₂O₇; Ni-site type lithium nickel oxide represented by chemical formula LiNi_{1-c2}M_{c2}O₂ (where M is at least one selected from the group consisting of Co, Mn, Al, Cu, Fe, Mg, B, and Ga, and satisfies 0.01≤c2≤0.6); a lithium manganese composite oxide represented by chemical formula LiMn_{2-c3}M_{c3}O₂ (where M is at least one selected from the group consisting of Co, Ni, Fe, Cr, Zn and Ta, and satisfies 0.01≤c3≤0.6) or Li₂Mn₃MO₈ (where M is at least one selected from the group consisting of Fe, Co, Ni, Cu and Zn.); LiMn₂O₄ in which a part of Li of the chemical formula is substituted with an alkaline earth metal ion, or the like, but is not limited thereto. The positive electrode may be Li metal.

In the exemplary embodiment of the present disclosure, the positive electrode active material includes a lithium composite transition metal compound including nickel (Ni), cobalt (Co), and manganese (Mn), the lithium composite transition metal compound includes single particles or secondary particles, and an average particle diameter (D50) of the single particles may be 1 μm or greater.

For example, the average particle diameter (D50) of the single particles may be 1 μm or greater and 12 μm or less, 1 μm or greater and 8 μm or less, 1 μm or greater and 6 μm or less, greater than 1 μm and 12 μm or less, greater than 1 μm and 8 μm or less, or greater than 1 μm and 6 μm or less.

Even when the single particles are formed with a small average particle diameter (D50) of 1 μm or greater and 12 μm or less, the particle strength may be excellent. For example, the single particle may have a particle strength of 100 to 300 MPa when roll-pressing with a force of 650 kgf/cm². Accordingly, even when the single particles are roll-pressed with a strong force of 650 kgf/cm², the increase phenomenon of micro-particles in an electrode due to particle breakage is alleviated, thereby improving the lifetime characteristic of the battery.

The single particles may be manufactured by mixing and firing a transition metal precursor and a lithium source material. The secondary particles may be manufactured by a method different from that of the single particles, and the composition thereof may be the same as or different from that of the single particles.

The method of forming the single particles is not particularly limited, but generally can be formed by over-firing with raised firing temperature, or may be manufactured by using additives such as grain growth promoters that help over-firing, or by changing a starting material.

For example, the firing can be performed at a temperature at which single particles can be formed. To achieve this end, according to certain embodiments, the firing should be performed at a temperature higher than a temperature during manufacture of the secondary particles. For example, when the composition of the precursor is the same, the firing should be performed at a temperature about 30° C. to 100° C. higher than a temperature during manufacture of the secondary particles. The firing temperature for forming the single particles may vary depending on the metal composition in the precursor. For example, when forming single particles with a high-Ni NCM-based lithium composite transition metal oxide having a nickel (Ni) content of 80 mol % or more, the firing temperature may be about 700° C. to 1000° C., and preferably about 800° C. to 950° C. According to certain aspects, when the firing temperature satisfies the above range, a positive electrode active material including single particles having excellent electrochemical properties can be manufactured. If the firing temperature is below 790° C., a positive electrode active material including a lithium composite transition metal compound in the form of secondary particles may be manufactured, and if the firing temperature exceeds 950° C., excessive firing occurs and a layered crystal structure may not be properly formed, so that the electrochemical properties may be deteriorated.

In the present disclosure, the single particle is a term used to distinguish the same from typical secondary particles resulting from agglomeration of tens to hundreds of primary particles, and is a concept including a single particle consisting of one primary particle and a quasi-single particle form that is an agglomerate of 30 or less primary particles.

Specifically, according to aspects of the present disclosure, the single particle may be a single particle consisting of one primary particle or a quasi-single particle form that is an agglomerate of 30 or less primary particles, and the secondary particle may be an agglomerate form of hundreds of primary particles.

In the exemplary embodiment of the present disclosure, the lithium composite transition metal compound, which is the positive electrode active material, further includes secondary particles, and the average particle diameter (D50) of the single particles is smaller than the average particle diameter (D50) of the secondary particles.

According to aspects of the present disclosure, the single particle may be a single particle consisting of one primary particle or a quasi-single particle form that is an agglomerate of 30 or less primary particles, and the secondary particle may be an agglomerate form of hundreds of primary particles.

The above-described lithium composite transition metal compound may further include secondary particles. The secondary particle means a form formed by agglomeration of primary particles, and can be distinguished from the concept of a single particle including one primary particle, one single particle and a quasi-single particle form, which is an agglomerate of 30 or less primary particles.

The secondary particle may have a particle diameter (D50) of 1 μm to 20 μm, 2 μm to 17 μm, and preferably 3 μm to 15 μm. The specific surface area (BET) of the secondary particles may be 0.05 m²/g to 10 m²/g, preferably 0.1 m²/g to 1 m²/g, and more preferably 0.3 m²/g to 0.8 m²/g.

In a further exemplary embodiment of the present disclosure, the secondary particle is an agglomerate of primary particles, and the average particle diameter (D50) of the primary particles is 0.5 μm to 3 μm. Specifically, the secondary particle may be an agglomerate form of hundreds of primary particles, and the average particle diameter (D50) of the primary particles may be 0.6 μm to 2.8 μm, 0.8 μm to 2.5 μm, or 0.8 μm to 1.5 μm.

According to certain aspects, when the average particle diameter (D50) of the primary particles satisfies the above range, a single-particle positive electrode active material having excellent electrochemical properties can be formed. If the average particle diameter (D50) of the primary particles is too small, the number of agglomerates of primary particles forming lithium nickel-based oxide particles may increase, which may reduce the effect of suppressing particle breakage during roll-pressing, and if the average particle diameter (D50) of the primary particles is too large, a lithium diffusion path inside the primary particles may be lengthened, which may increase a resistance and degrade an output characteristic.

According to a further exemplary embodiment of the present disclosure, the average particle diameter (D50) of the single particles is smaller than the average particle diameter (D50) of the secondary particles. As a result, according to certain aspects, the single particles may have excellent particle strength even if they are formed with a small particle diameter, and accordingly, the increase phenomenon of micro-particles in an electrode due to particle breakage may be alleviated, thereby improving the lifetime characteristic of the battery.

In an exemplary embodiment of the present disclosure, the average particle diameter (D50) of the single particles is smaller than the average particle diameter (D50) of the secondary particles.

For example, the average particle diameter (D50) of the single particles may be 1 μm to 16 μm smaller, 1.5 μm to 15 μm smaller, or 2 μm to 14 μm smaller than the average particle diameter (D50) of the secondary particles.

According to certain aspects, when the average particle diameter (D50) of the single particles is smaller than the average particle diameter (D50) of the secondary particles, for example, when the above range is satisfied, the single particles may have excellent particle strength even if they are formed with a small particle diameter, and as a result, the increase phenomenon of micro-particles in an electrode due to particle breakage may be alleviated, thereby improving the lifetime characteristic of the battery and the energy density.

According to a further exemplary embodiment of the present disclosure, the single particles are included in an amount of 15 parts by weight to 100 parts by weight based on 100 parts by weight of the positive electrode active material. The single particles may be included in an amount of 20 parts by weight to 100 parts by weight, or 30 parts by weight to 100 parts by weight based on 100 parts by weight of the positive electrode active material.

For example, the single particles may be included in an amount of 15 parts by weight or more, 20 parts by weight or more, 25 parts by weight or more, 30 parts by weight or more, 35 parts by weight or more, 40 parts by weight or more, or 45 parts by weight or more based on 100 parts by weight of the positive electrode active material. The single particles may be included in an amount of 100 parts by weight or less based on 100 parts by weight of the positive electrode active material.

According to certain aspects, when the single particles are included within the above range, excellent battery characteristics may be exhibited in combination with the negative electrode material described above. In particular, when the single particles are included in an amount of 15 parts by weight or more, the increased phenomenon of micro-particles in an electrode due to particle breakage in a roll-pressing process after fabrication of an electrode can be alleviated, thereby improving the lifetime characteristics of the battery.

In the exemplary embodiment of the present disclosure, the lithium composite transition metal compound may further include secondary particles, and the secondary particles may be included in an amount of 85 parts by weight or less based on 100 parts by weight of the positive electrode active material. The secondary particles may be included in an amount of 80 parts by weight or less, 75 parts by weight or less, or 70 parts by weight or less based on 100 parts by weight of the positive electrode active material. The secondary particles may be included in an amount of 0 part by weight or more based on 100 parts by weight of the positive electrode active material.

According to certain aspects, when the above range is satisfied, the above-described effects due to the existence of the single particles in the positive electrode active material can be maximized. In the case in which the positive electrode active material of the secondary particles is included, the components thereof may be the same as or different from those exemplified in the single-particle positive electrode active material described above, and may mean an agglomerate form of single particles.

In the exemplary embodiment of the present disclosure, the positive electrode active material in 100 parts by weight of the positive electrode active material layer may be included in an amount of 80 parts by weight or more and 99.9 parts by weight or less, preferably 90 parts by weight or more and 99.9 parts by weight or less, more preferably 95 parts by weight or more and 99.9 parts by weight or less, most preferably 98 parts by weight or more and 99.9 parts by weight or less.

The positive electrode active material layer may include a positive electrode conductive material and a positive electrode binder together with the positive electrode active material described above.

In this case, according to certain aspects, the positive electrode conductive material may be used to impart conductivity to the electrode, and can be used without particular limitation as long as the positive electrode conductive material has electronic conductivity without causing a chemical change in a battery to be constituted. Specific examples may include graphite such as natural graphite and artificial graphite; a carbon-based material such as carbon black, acetylene black, Ketjen black, channel black, furnace black, lamp black, thermal black and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative, or the like, and any one thereof or a mixture of two or more thereof may be used.

In addition, according to certain aspects, the positive electrode binder serves to improve bonding between particles of the positive electrode active material and adhesive force between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, polytetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

The separator serves to separate the negative electrode and the positive electrode and to provide a migration path of lithium ions, in which any separator may be used as the separator without particular limitation as long as it is typically used in a secondary battery, and particularly, a separator having high moisture-retention ability for an electrolyte as well as a low resistance to the migration of electrolyte ions may be preferably used. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a usual porous non-woven fabric, for example, a non-woven fabric formed of high melting point glass fibers, polyethylene terephthalate fibers, or the like may be used. Furthermore, a coated separator including a ceramic component or a polymer material may be used to secure heat resistance or mechanical strength, and the separator having a single layer or multilayer structure may be selectively used.

Examples of the electrolyte may include an organic liquid electrolyte, an inorganic liquid electrolyte, a solid polymer electrolyte, a gel-type polymer electrolyte, a solid inorganic electrolyte, or a molten-type inorganic electrolyte that may be used in the manufacturing of the lithium secondary battery, but are not limited thereto.

Specifically, the electrolyte may include a non-aqueous organic solvent and a metal salt.

As the non-aqueous organic solvent, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

In particular, among the carbonate-based organic solvents, ethylene carbonate and propylene carbonate, which are cyclic carbonates, are high-viscosity organic solvents and can be preferably used because they have high permittivity to dissociate a lithium salt well. When the cyclic carbonate is mixed with a linear carbonate with low viscosity and low permittivity, such as dimethyl carbonate and diethyl carbonate, in a suitable ratio and used, an electrolyte having high electric conductivity may be prepared, and therefore, may be more preferably used.

A lithium salt may be used as the metal salt, and the lithium salt is a material that is readily soluble in the non-aqueous electrolyte, in which, for example, one or more species selected from the group consisting of F⁻, Cl⁻, I⁻, NO₃⁻, N(CN)₂₋, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (ESO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂, SCN⁻ and (CF₃CF₂SO₂)₂N⁻ may be used as an anion of the lithium salt.

One or more additives, for example, a haloalkylene carbonate-based compound such as difluoroethylene carbonate, pyridine, triethylphosphite, triethanolamine, cyclic ether, ethylenediamine, n-glyme, hexamethyl phosphoric triamide, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride, may be further included in the electrolyte for the purpose of improving life characteristics of the battery, suppressing a decrease in battery capacity, improving discharge capacity of the battery, and the like, in addition to the above-described electrolyte components.

An exemplary embodiment of the present disclosure provides a battery module including the secondary battery as a unit cell, and a battery pack including the same. Since the battery module and the battery pack include the secondary battery having high capacity, high-rate capability, and high cycle characteristics, the battery module and the battery pack may be used as a power source of a medium to large sized device selected from the group consisting of an electric vehicle, a hybrid electric vehicle, a plug-in hybrid electric vehicle, and a power storage system.

Hereinafter, preferred examples will be provided for better understanding of the present disclosure. It will be apparent to one skilled in the art that the examples are only provided to illustrate aspects of the present disclosure and various modifications and alterations are possible within the scope and technical spirit of the present invention. Such modifications and alterations naturally fall within the scope of claims included herein.

### PREPARATION EXAMPLES

### Preparation of Negative Electrode

Si (average particle diameter (D50): 3.5 μm) serving as a silicon-based active material, a first conductive material, a second conductive material, and polyacrylamide serving as a binder were added to distilled water serving as a solvent for formation of a negative electrode slurry at a weight ratio of 80:10:0.4:9.6 to prepare a negative electrode slurry (solid concentration: 25 wt %).

The first conductive material was plate-like graphite (specific surface area: 17 m²/g, average particle diameter (D50): 3.5 μm), and the second conductive material was single-walled carbon nanotube (SWCNT).

As a mixing method, after dispersing the first conductive material, the second conductive material, the binder and water at 2500 rpm for 30 minutes with a homo mixer, the active material was added to the dispersion, which was then dispersed at 2500 rpm for 30 minutes to fabricate a slurry.

The negative electrode slurry was coated on both surfaces of a copper current collector (thickness: 8 μm) serving as a negative electrode current collector with a loading amount of 85 mg/25 cm², which was then roll-pressed and dried in a vacuum oven at 130° C. for 10 hours to form a negative electrode active material layer whereby a negative electrode was prepared (porosity of negative electrode: 40.0%).

Thereafter, a pattern was formed in the negative electrode active material layer using a laser, and the shape of the pattern and the information thereof were shown in Table 1 below. In this case, the total volume (A+B) of the negative electrode active material layer was formed to be the same, and the experiment was conducted by changing only the volume of the pattern portion.

TABLE 1

| | Pattern | | | |
|---|---|---|---|---|
| | shape | Formula 1 | Formula 2 | Formula 3 |
| Example 1 | 2D pattern | 25 | 30 | 80 |
| Example 2 | 1D pattern | 10 | 40 | 90 |
| Example 3 | 2D pattern | 10 | 35 | 83 |
| Example 4 | V pattern, | 13 | 43 | 92 |
| | 2D pattern | | | |
| Comparative | — | — | — | — |
| Example 1 | | | | |
| Comparative | 2D pattern | 3 | 55 | 102 |
| Example 2 | | | | |
| Comparative | 2D pattern | 35 | 22 | 60 |
| Example 3 | | | | |

In Table 1, Comparative Example 1 corresponds to a case where the negative electrode for the secondary battery was manufactured in the same manner as described above, except that the pattern was not formed.

### Experimental Example 1. Evaluation of Initial Discharge Capacity

For the secondary batteries including the negative electrodes prepared in the Examples and the Comparative Examples, the first discharge capacity was measured at 4.2-3.0V 0.33 C/0.33 C using an electrochemical charge/discharge device.

### Experimental Example 2. Evaluation of Life Characteristics of Monocell at Room Temperature

For the secondary batteries including the negative electrodes prepared in the Examples and Comparative Examples, the life and the capacity retention rate were evaluated using an electrochemical charging and discharging device. The secondary batteries were subjected to a cycle test at 4.2-3.0 V 1 C/0.5 C, and the number of cycles at which the capacity retention rate reached 80% was measured.

capacity retention rate (%)={(discharge capacity at Nth cycle)/(discharge capacity at first cycle)}×100

### Experimental Example 3. Evaluation of Resistance Increase Rate Measurement

After the capacity retention rates were measured by charging/discharging the secondary batteries at 0.33 C/0.33 C (4.2-3.0V) every 50 cycles during the test in Experimental Example 2, the resistance increase rates were compared and analyzed by discharging the secondary batteries at 2.5 C pulse in SOC50 to measure the resistance.

For the evaluation of the resistance increase rate measurement, data at 150 cycles was each calculated.

### Experimental Example 4. Evaluation of Cell Swelling

For the cells evaluated in Experimental Example 2, the overall thickness increase rate of the cell was calculated after formation in a state of 150 cycles of discharge (3.0V).

### Experimental Example 5. Evaluation of Pore Resistance

Coin symmetric cells were prepared using the negative electrodes prepared in the Examples and the Comparative Examples, and the pore resistance was calculated by measuring impedances from 300 kHz to 300 mHz at 25° C. with EIS.

The evaluation results of Experimental Examples 1 to 5 are shown in Table 2 below.

TABLE 2

| | Example | Example | Example | Example | Comparative | Comparative | Comparative |
|---|---|---|---|---|---|---|---|
| | 1 | 2 | 3 | 4 | Example 1 | Example 2 | Example 3 |
| Experimental | 118 | 119 | 118 | 118 | 120 | 119 | 116 |
| Example 1 | | | | | | | |
| (mAh) | | | | | | | |
| Experimental | 190 | 188 | 189 | 188 | 185 | 185 | 190 |
| Example 2 | | | | | | | |
| (number of | | | | | | | |
| times) | | | | | | | |
| Experimental | 38 | 41 | 40 | 39 | 45 | 44 | 38 |
| Example 3 | | | | | | | |
| (%) | | | | | | | |
| Experimental | 6 | 8 | 7 | 8 | 10 | 9 | 6 |
| Example 4 | | | | | | | |
| (%) | | | | | | | |
| Experimental | 2.71 | 2.91 | — | — | 3.55 | — | — |
| Example 5 | | | | | | | |
| (ohm) | | | | | | | |

The negative electrode for the lithium secondary battery according to aspects of the present disclosure includes a silicon-based active material and targets high capacity and high energy density. In this case, according to certain aspects, the silicon-based active material may be included in a high content in the negative electrode active material layer, and accordingly, volume expansion during charging and discharging may be problematic. In the case of the negative electrodes of Examples 1 to 4, the negative electrode active material layer includes a pattern portion, and in particular, it can be confirmed that the volumes of the pattern portion and the negative electrode active material layer satisfy the relationship of Formula 1 above.

Accordingly, it could be confirmed that the negative electrode including a negative electrode active material layer satisfying Formula 1 above can maximize the life characteristics of a lithium secondary battery by reducing the volume expansion during charging and discharging, and can provide a lithium secondary battery with excellent rapid charging performance while having the characteristics of high density and high capacity, which are the advantages of a silicon-based negative electrode.

Comparative Example 1 is a negative electrode that does not include a pattern portion, and as can be seen in Experimental Example 2, the life characteristics deteriorated, as can be seen in Experimental Example 3, the resistance increase rate was high, and as can be seen in Experimental Example 4, cell swelling was high. This results from the fact that the pattern portion capable of preventing the volume expansion and relaxation of the silicon-based active material (especially pure Si) was not formed, and it could be confirmed that the life characteristics dramatically deteriorated.

Comparative Example 2 corresponds to a case where the negative electrode active material layer has a pattern portion as in aspects of the present disclosure, but the range is less than the range of Formula 1, that is, the volume of the pattern portion is less than the volume set according to aspects of the present disclosure. Also in this case, the same results as Comparative Example 1 can be exhibited. That is, it could be confirmed that when the volume of the pattern portion is less than the set volume, the life characteristics deteriorated to the same extent as when the pattern portion is not formed.

Comparative Example 3 corresponds to a case where the volume of the pattern portion is larger than the volume set according to aspects of the present disclosure (that is, when the range of Formula 1 is exceeded). In this case, it could be confirmed that the life characteristics were similar to the Examples of the present disclosure. However, it can be confirmed that the desired capacity cannot be achieved in Experimental Example 1 as a result of excessively securing the pattern portion in order to control the volume expansion. That is, pure Si, which has better capacity characteristics than carbon-based active materials, was used to ensure capacity characteristics and rapid charging. However, it could be confirmed that when the pattern portion was formed excessively to ensure only the lifespan characteristics, the capacity characteristics rather deteriorated and the corresponding negative electrode could not be used as a negative electrode.

In conclusion, when the range of Formula 1 above is satisfied, the volume expansion can be controlled not only in stack-type pouch batteries but also in cylindrical and prismatic batteries wound into a roll shape, resulting in an advantageous effect on high energy density and high-capacity characteristics. In addition, it could be confirmed through the Experimental Examples that there is no difference in volume expansion even when the formation charging speed is increased compared to the existing condition, and not only expansions in the x and y directions but also thickness change in the z direction can be reduced.

1. A negative electrode for a lithium secondary battery comprising:
a negative electrode current collector layer; and
a negative electrode active material layer formed on at least one surface of the negative electrode current collector layer,
wherein the negative electrode active material layer comprises a pattern portion and satisfies Formula 1 below:
$$5 \leq [ B / ( A + B ) ] \times 100 ( \% ) \leq 30 \qquad [ ‐ Formula 1 ‐ ]$$
in Formula 1 above,
A refers to a volume of the negative electrode active material layer excluding the pattern portion, and
B refers to a volume of the pattern portion of the negative electrode active material layer.

2. The negative electrode for the lithium secondary battery of claim 1, wherein the negative electrode active material layer satisfies Formula 2 below:
$$[ \{ ( x + x 1 ) ( y + y 1 ) ( z + z 1 ) - x yz \} / xyz ] \times 100 ( \% ) < 50 \% \qquad [ ‐ Formula 2 ‐ ]$$
in Formula 2 above,
x, y, and z are a total width, a total length, and a total thickness of the negative electrode active material layer comprising the pattern portion, respectively, after manufacturing the negative electrode for the lithium secondary battery, and
x1, y1, and z1 are changes in length in the x, y, and z directions, respectively, after manufacturing the negative electrode for the lithium secondary battery, and immediately after ⅓ C CC-CV charge to 4.2V (0.05 C cut-off) followed by ⅓ C CC discharge to 2.5V.

3. The negative electrode for the lithium secondary battery of claim 1, wherein the negative electrode active material layer satisfies Formula 3 below:
$$[ \{ ( x + x 2 ) ( y + y 2 ) ( z + z 2 ) - x yz \} / xyz ] \times 100 ( \% ) < 100 \% \qquad [ ‐ Formula 3 ‐ ]$$
in Formula 3 above,
x, y, and z are a total width, a total length, and a total thickness of the negative electrode active material layer comprising the pattern portion, respectively, after manufacturing the negative electrode for the lithium secondary battery, and
x2, y2, and z2 refer to changes in length in the x, y, and z directions, respectively, of the negative electrode active material layer, after manufacturing the negative electrode for the lithium secondary battery followed by 300 cycles of 1 C CC-CV charge to 4.2V (0.05 C cut-off) and 0.5 C CC discharge to 3.0V.

4. The negative electrode for the lithium secondary battery of claim 1, wherein the negative electrode active material layer satisfies Formula 4 below:
$$5 \leq xyz - \{ ( xi \times n ) yz + x ( yj \times m ) z - nmxiyj \} \leq 30 \qquad [ ‐ Formula 4 ‐ ]$$
in Formula 4 above,
x, y, and z are a total width, a total length, and a total thickness of the negative electrode active material layer comprising the pattern portion, respectively, after manufacturing the negative electrode for the lithium secondary battery, and
n is the number of patterns in the x direction,
m is the number of patterns in the y direction,
xi refers to a width of each pattern in the x direction,
yj refers to a length of each pattern in the y direction,
i is an integer ranging from 1 to n, and
j is an integer ranging from 1 to m.

5. The negative electrode for the lithium secondary battery of claim 1, wherein the pattern portion comprises one or more selected from the group consisting of a 1D pattern, a 2D pattern, a V pattern, and a U pattern.

6. The negative electrode for the lithium secondary battery of claim 1, wherein the negative electrode active material layer comprises a negative electrode active material layer composition, and
wherein the negative electrode active material layer composition comprises a silicon-based active material, a negative electrode conductive material, and a negative electrode binder.

7. The negative electrode for the lithium secondary battery of claim 6, wherein the silicon-based active material comprises one or more selected from the group consisting of SiOx (x=0) and SiOx (0<x<2) and comprises 70 parts by weight or more of the SiOx (x=0) based on 100 parts by weight of the silicon-based active material.

8. The negative electrode for the lithium secondary battery of claim 6, wherein the silicon-based active material is included in an amount of 60 parts by weight or more based on 100 parts by weight of the negative electrode active material layer composition.

9. The negative electrode for a lithium secondary battery of claim 6, wherein the negative electrode conductive material comprises a planar conductive material and a linear conductive material, and
wherein the planar conductive material is included in an amount of 80 parts by weight or more and 99.9 parts by weight or less and the linear conductive material is included in an amount of 0.1 part by weight or more and 20 parts by weight or less based on 100 parts by weight of the negative electrode conductive material.

10. The negative electrode for the lithium secondary battery of claim 6, wherein the negative electrode conductive material is included in an amount of 10 parts by weight or more and 40 parts by weight or less based on 100 parts by weight of the negative electrode active material layer composition.

11. The negative electrode for the lithium secondary battery of claim 1, wherein a thickness of the negative electrode current collector layer is 1 μm or greater and 100 μm or less, and
wherein a thickness of the negative electrode active material layer is 20 μm or greater and 500 μm or less.

12. A lithium secondary battery comprising:
a positive electrode;
the negative electrode for the lithium secondary battery of claim 1;
a separator provided between the positive electrode and the negative electrode; and
an electrolyte.
